(19) United States
(12) Patent Application Publication
(10) Pub. No.: US 2004/0118838 A1
(43) Pub. Date: Jun. 24, 2004

(54) Multi-purpose microwave cooking vessel

(76) Inventor: Jong Peter Park, Los Angeles, CA (US)

Correspondence Address: JONG PETER PARK, SUITE B, 824 WILSHIRE BLVD., LOS ANGELES, CA, 90017, US

(21) Appl. No.: 10/716,332

(22) Filed: Nov. 18, 2003

Related U.S. Application Data
(60) Provisional application No. 60/427,030, filed on Nov. 18, 2002.

(51) Int. Cl. H05B 6/80

(52) U.S. Cl. 219/725; 219/730

(57) ABSTRACT

In a cooking vessel for use in a microwave oven, a microwave cooking vessel comprises a vessel a having a bottom surface, a body wall, and an open region, wherein the open region extends upwardly from the bottom surface to terminate at the peripheral flange; a heating element adapted to convert microwave radiation into thermal energy, the heating element composed primarily of a mixture of elastic material and ferrite particles, wherein the top face of the heating element is attached to the outer bottom surface of the vessel so as to distribute heat along the bottom of the vessel; and a cover having a dome-shape and comprising a handle for engaging and disengaging the cover onto the vessel, plurality of apertures which provides a pathway for heated air and moisture so that the cover does not disengage from the vessel when the microwave cooking vessel is in use, and an annular flange which sits on the peripheral flange of the vessel when the cover is engaged to the vessel, wherein the cover is composed primarily of microwave radiation reflecting material so as to reflect microwave radiation and preserve the taste of foodstuff being cooked in the microwave cooking vessel.

### CROSS REFERENCE TO RELATED ART

This application claims the benefit of U.S. Provisional Application No. 60/427,030 filed on Nov. 18, 2002, which is herein incorporated by reference.

### BACKGROUND OF THE INVENTION

The present invention relates to a multi-purpose cooking vessel for a microwave oven. Specifically, the present invention relates to a heating element for a microwave cooking vessel adapted to convert high-frequency electromagnetic radiation into thermal energy. Even more specifically, the present invention relates to a cover for a microwave cooking vessel adapted to preserves the taste of the food being cooked.

A problem with microwave cooking is that food comes out dry, or comes out with patches of heated and unheated areas. The main cause of this problem is that microwave ovens cook food in a unique way: a microwave oven utilizes a klystron to generate high-frequency electromagnetic waves that have an affinity to react with water. Although this property of oscillating water molecules to create frictional heat is what essentially makes a microwave cook efficiently, it is also the primary reason a microwave oven cannot brown or crisp food as in a conventional oven or stove.

Numerous cooking vessels have evolved over the years for solving the problem of microwave cooking; however, many of the known vessels have suffered from a number of shortcomings such as failing to work properly, being difficult to operate and overly expensive to fabricate. The most relevant known prior arts comprise U.S. Pat. No. 3,941,967, which teaches a heating element that produces thermal energy by absorption of microwave radiation; U.S. Pat. No. 4,496,815, which teaches a metal platter with ferritic-silicon coating placed on a housing; and U.S. Pat. No. 5,496,103, which teaches a microwave baking utensil with ferrite dispersed throughout an epoxy matrix.

The present invention overcomes the shortcomings of the foregoing patents in providing a microwave cooking vessel that is efficient in its use of high-frequency radiation, preserves the taste of the food being prepared, can be used for a variety of cooking applications, and is also economical to fabricate.

### SUMMARY OF THE INVENTION

Accordingly, the present invention is directed to a cooking vessel for a microwave oven that substantially obviates one or more problems due to limitations and disadvantages of the related art.

An object of the present invention is to provide a new and improved microwave cooking vessel.

Another object of the present invention is to provide a microwave cooking vessel which can be use for a variety of cooking applications such as grilling, reheating, browning, crisping, frying, baking and roasting.

Yet another object of the present invention is to provide a microwave cooking vessel that is economical to fabricate.

Yet even another object of the present invention is to provide a microwave cooking vessel that preserves the taste of the food being cooked.

And yet even another object of the present invention is to provide a microwave cooking vessel that makes efficient use of microwave radiation.

Additional advantages, objects, and features of the present invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in a cooking vessel for use in a microwave oven, a microwave cooking vessel comprises a vessel a having a bottom surface, a body wall, and an open region, wherein the open region extends upwardly from the bottom surface to terminate at the peripheral flange; a heating element adapted to convert microwave radiation into thermal energy, the heating element composed primarily of a mixture of elastic material and ferrite particles, wherein the top face of the heating element is attached to the outer bottom surface of the vessel so as to distribute heat along the bottom of the vessel; and a cover having a dome-shape and comprising a handle for engaging and disengaging the cover onto the vessel, plurality of apertures which provides a pathway for heated air and moisture so that the cover does not disengage from the vessel when the microwave cooking vessel is in use, and an annular flange which sits on the peripheral flange of the vessel when the cover is engaged to the vessel, wherein the cover is composed primarily of microwave radiation reflecting material so as to reflect microwave radiation and preserve the taste of foodstuff being cooked in the microwave cooking vessel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and, together with the description, serve to explain the principle of the invention. In the drawings:

FIG. 1 illustrates a perspective view of a microwave cooking vessel according to a preferred embodiment of the present invention;

FIG. 2 illustrates a cross-sectional view of a microwave cooking vessel according to a preferred embodiment of the present invention;

FIG. 3 illustrates a bottom plan view of a microwave cooking vessel according to the preferred embodiment of the present invention; and

FIG. 4 illustrates a perspective view of a heating element of a microwave cooking vessel according to the preferred embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

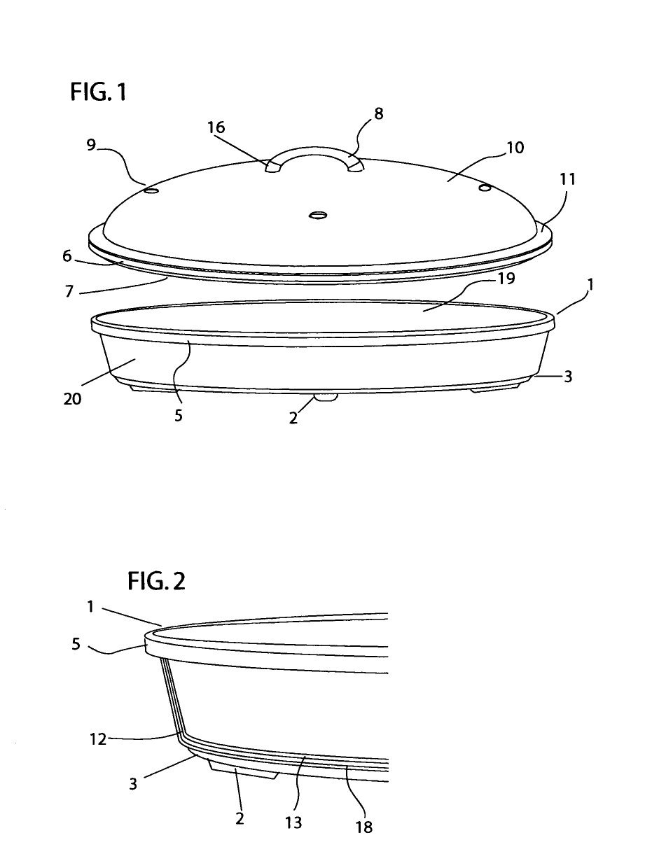

FIG.1 illustrates a perspective view of a multi-purpose microwave cooking vessel according to a preferred embodiment of the present invention.

As shown, a multi-purpose microwave cooking vessel comprises a cover 10, a vessel 1 and a heating element 3.

The vessel 1 comprises a bottom surface, an open region 19, a body wall 20 and a peripheral flange 5. Preferably, the bottom surface is flat and extending up from it and terminating at the peripheral flange 5 is the body wall 20. The peripheral flange 5 is designed to be easily and economically fabricated, and is also designed to make the vessel 1 compact. As shown in FIG. 1, the peripheral flange 5 is folded; however it can also be rolled or reduced in diameter by any other suitable process known to one of ordinary skill in the art.

A compact design is important because many household microwave ovens are small and for the vessel to work at a high level of efficiency, clearing space is needed all around the vessel. Preferably, the diameter of the vessel is predetermined so as to allow at least 1 to 2 cm of clearing space in a small household microwave oven; more preferably, the diameter of the vessel is about 24 cm.

FIG. 2 illustrates a cross-sectional view of a microwave cooking vessel according to a preferred embodiment of the present invention. As shown, the body of the vessel includes plurality of layers: a non-stick layer 13, a thermal conductive layer 12, and a protective layer 18.

The innermost layer is the non-stick layer 13 and is composed primarily of a non-stick compound that substantially prevents food from sticking to the vessel, especially in the areas of high temperature gradients, such as directly adjacent the heating element. Preferably, the inner layer is composed of a non-stick compound having a polytetrafluoroethylene (PTFE) base; more preferably, the inner layer 13 is composed of at least two coats of the non-stick compound.

The middle layer is the thermal conductive layer 12 and is composed of high thermal conductive material such as copper, aluminum and stainless steel. Preferably, the thermal conductive layer 12 is composed of aluminum, which is generally lightweight, inexpensive and is also a good thermal conductor.

The outermost layer is the protective layer 18 and is made up primarily of heat resistant paint for protection and easy cleaning. Preferably, the protective layer 18 is composed primarily of paint that can withstand at least 210° C. The protective layer 18 has to withstand such temperature because the vessel 1 can reach temperatures above 210° C. in less than 3 minutes in some microwave ovens.

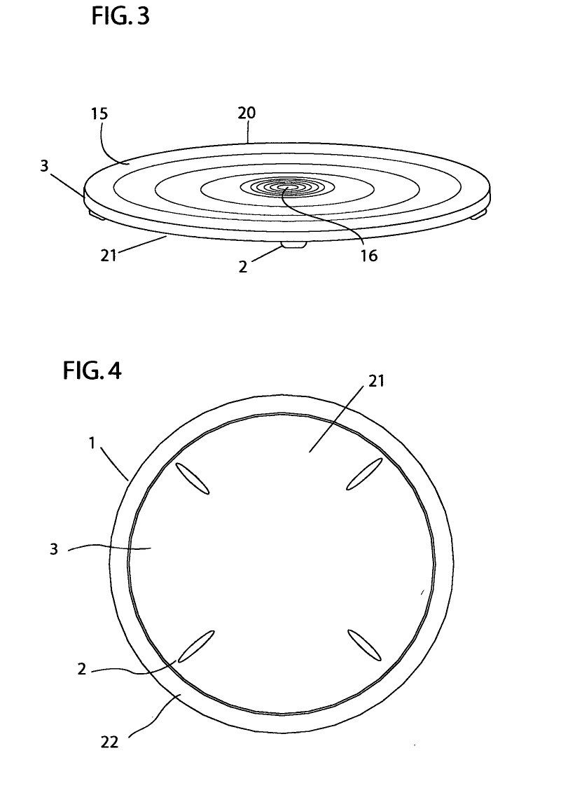

FIG. 3-4 illustrates a heating element 3 for a microwave cooking vessel according to the preferred embodiment of the present invention. The heating element 3 has a top 20 and bottom face 21, and the top face 20 is attached to the outer bottom surface 22 of the vessel 1. Preferably, the heating is attached to the outer bottom surface 22 of the vessel 1 by a heat press process. The heat press process comprises the following steps: applying a layer of adhesive to the outer bottom surface 22 of the vessel 1, drying the vessel 1 for about an hour in an area having a temperature about 180° C. and pressing the heating element 3 onto vessel 1 at temperatures ranging between 150-250° C. This heat-press process removes excess water, minimizes shrinkage and ensures greater resistance to high temperature, moisture and physical abuse.

In the present invention, the heating element is ferrite rubber, a mixture of ferrite particles having the general chemical formula MO.Fe2O3, where MO is one or more divalent metal oxides combined with 48 to 60 mole percent of iron oxide, and elastic material. Preferably, the elastic material is silicon rubber capable of withstanding temperatures up to at least the transitional temperature of the ferrite particles, which is temperature marking the change of the particles from a ferromagnetic to paramagnetic state. More preferably, the elastic material is silicon rubber capable of withstanding at least 260° C.

The use of ferrite rubber as a heating element 3 offers several advantages over coating a vessel with ferrite particles. First, it is durable in that it is flexible and strong enough to be used in demanding conditions such as in a microwave oven or in a sink. It is also durable in that it protects the magnetic properties of the ferrite particles by being moisture resistant. Secondly, it is moldable in that it can be molded into varying shape or size. For example, in the preferred embodiment, the thermal insulating members 2, which are described below, are molded directed onto the bottom face of the heating element 3. This eliminates the manufacturing steps of separately attaching the thermal insulating members 2 onto the bottom face of the heating element.

Also, the use of ferrite rubber provides the vessel with a level of temperature control. For example, the heating element can be pitched to give uniform heat distribution or can be graduated to give varying heat across its surface. In the preferred embodiment, the heating element is pitched as ferrite particles are dispersed evenly throughout the heating element; however, as shown in FIG. 3, the heating element can be graduated by being sub divided into heating zones as shown in FIG. 3. The central zone 16 having a greater concentration of ferrite particles than the outermost zone 15. This allows microwave cooking vessel to cook most efficiently as heat is not wasted on areas where foodstuff is less prevalent.

Moreover, the temperature can also be controlled in that the heating element 3 is acting as a thermal blanket. Besides generating thermal energy and transferring that energy to the vessel 1, the heating element 3 protects the vessel 1 from rapid heat loss. Once heated, the heating element remains heated for a substantial period of time, even after the microwave oven is shut off.

FIG. 4 illustrates a bottom plan view of a microwave cooking vessel according to the preferred embodiment of the present invention. Provided on the bottom face of the heating element is a plurality of thermal insulating members 2. Preferably, at least four thermal insulating members 2 are geometrically arranged on the bottom face of the heating element 3 to provide support for the vessel 1. The thermal insulating members 2 are narrow-shaped so as to make minimal contact with the inner surface or turntable of the microwave oven, and thus provide insulation to the vessel 1 by ensuring that the thermal energy stored in the heating element 3 is not rapidly transferred to the inner surface of the microwave oven

FIG. 1 shows a cover 10 for a microwave cooking vessel according to the preferred embodiment of the present invention. The cover 10 serves two main functions: it shields foodstuff from microwave radiation, and traps heat and moisture. Preferably, the cover 10 is dome-shaped so as to allow easy circulation of heat and moisture and is composed primarily of microwave reflecting material and not of non-reflecting materials, such as paper, plastic or glass. Preferably, the cover 10 is composed of stainless steel.

The cover comprises a handle 16, plurality of apertures 9, an annular flange 11 and an elastic ring 6. The handle is attached onto the cover by any suitable process known to one of ordinary skill in the art, preferable by means of welding. Like the cover, the handle is composed primarily of microwave reflecting material and does not have sharp points or odd things about its shape, which can cause sparks or arcs of electricity between two metals points. Preferably, the handle is covered by a protective member 8, which makes the handle convenient to touch. This is because the handle can become hot after the vessel is heated.

Preferably, the cover comprises at least four apertures 9 to vent steam. They are geometrically arranged on the outer regions of the cover 10 so that the cover 10 does not disengage from the vessel 1 in any one position when pressure is built up. In an alternate embodiment of the present invention, an elastic ring 6 is situated below the annular flange 11. The elastic ring 6 serves two main purposes. First, it ensures that moisture and heated air does not escape through the side of the vessel 1. Secondly, it protects the microwave cooking vessel from arcing which can occur between two metals in close proximity when the microwave is in use.

To summarize, the general operations of the microwave cooking vessel according to the preferred embodiment of the present invention is as follows. When the microwave cooking vessel is placed in the microwave oven and the oven is turned on, ferrite particles absorb microwave radiation and converts it to thermal energy. The thermal energy is then transferred to the elastic material of the heating element 3. The heating element 3 then transfers the heat to the base of the vessel 1. As the vessel 1 is being heated, the cover 10 simultaneously reflects microwave radiation and preserves the taste of the foodstuff being prepared by reflecting microwave radiation.

It will be apparent to those skilled in the art that various modifications and variations can be made in the present invention without departing from the spirit or scope of the inventions. Thus, it is intended that the present invention cover the modifications and variations of this invention provided they come within the scope of the appended claims and equivalents.

What is claimed is:

1. In a cooking vessel for use in a microwave oven, a microwave cooking vessel comprising:
a vessel a having a bottom surface, a body wall, and an open region, wherein the open region extends upwardly from the bottom surface to terminate at the peripheral flange;
a heating element adapted to convert microwave radiation into thermal energy, said heating element composed primarily of a mixture of elastic material and ferrite particles, wherein the top face of the said heating element is attached to the outer bottom surface of said vessel so as to distribute heat along the bottom of said vessel; and
a cover having a dome-shape and comprising a handle for engaging and disengaging said cover onto said vessel, plurality of apertures which provides a pathway for heated air and moisture so that said cover does not disengage from said vessel when the microwave cooking vessel is in use, and an annular flange which sits above of the peripheral flange of said vessel when said cover is engaged to said vessel, wherein said cover is composed primarily of microwave radiation reflecting material so as to reflect microwave radiation and preserve the taste of foodstuff being cooked in the microwave cooking vessel.

2. The microwave cooking vessel of claim 1, wherein the elastic material of said heating element is silicon rubber.

3. The microwave cooking vessel of claim 2, further comprising plurality of thermal insulating members provided on the bottom face of said heating element to provide support for said vessel and to also ensure that the thermal energy stored in said heating element is not rapidly transferred to an inner surface of the microwave oven.

4. The microwave cooking vessel of claim 3, wherein said heating element is attached to the outer bottom surface of the vessel by a heat press process, said heat press process comprising the steps of applying a layer of adhesive to the outer bottom surface of the vessel, drying the vessel for about an hour in an area having a temperature about 180° C. and pressing the top face of said heating element onto the outer bottom surface of said vessel at temperatures ranging between 150 to 250° C.

5. The microwave cooking vessel of claim 4, wherein said vessel further comprises a plurality of layers, a non-stick inner layer, a thermal conductive middle layer, and a protective outer layer .

6. The microwave cooking vessel of claim 5, wherein the thermal conductive middle layer of said vessel is primarily composed of aluminum metal.

7. The microwave cooking vessel of claim 6, wherein said cover further comprises an elastic ring to trap moisture and heated air, and to ensure that arcing does not occur in between the annular flange of said cover and the said vessel.

8. The microwave cooking vessel of claim 7, wherein said heating element further comprises a central heating zone and an outer heating zone, wherein the central zone has a greater concentration of ferrite particles than the outer zone.

9. The microwave cooking vessel of claim 8, wherein the protective outer layer is composed primarily of paint that can withstand at least 210° C.
